(19) United States
(12) Patent Application Publication
(10) Pub. No.: US 2003/0099246 A1
(43) Pub. Date: May 29, 2003

(54) Method and apparatus for self-link assessing router

(75) Inventors: Gregory W. Cox, Schaumburg, IL (US); AAron M. Smith, Streamwood, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 09/996,208

(22) Filed: Nov. 28, 2001

(51) Int. Cl. H04L 12/28; H04L 12/56

(52) U.S. Cl. 370/400; 370/392

(57) ABSTRACT

A router 104 can automatically self assess which of its interfaces are coupled to an active communication link and then identify which interface needs a new network address prefix. Existing and available network address prefixes can be utilized to automatically self configure interfaces as appropriate. The interfaces and their corresponding communication links that require a new address prefix can be flagged for subsequent attention.

### TECHNICAL FIELD

This invention relates generally to network routers.

### BACKGROUND

Network routers are well understood in the art and ordinarily function to forward messages to and/or from other hosts and routers. A router generally has two or more network interfaces into which connections to a link can be coupled. A link may typically comprise several devices interconnected by a networking hub such as an Ethernet hub. A router receives packets of information on these connections and retransmits them through other network interfaces according to decisions it makes about which packets to retransmit and the interface on which to retransmit those packets. Routers are used to connect networks, such as local area networks and the Internet, to each other.

The IETF's IPv6 (Internet Protocol version 6) is a newly developing network protocol intended, in part, to better accommodate numerous wireless endpoints (one good reference defining IPv6 is the text “IPv6 Clearly Explained” by Pete Loshin © 1999 by Academic Press and published by Morgan Kaufmann, San Francisco). Adding routers to an existing IPv6 system presents sometimes challenging logistic requirements. One of these challenges concerns address prefixes. (FIGS. 6.2 on page 98 and 6.3 on page 100 of the Loshin reference noted above provide examples of prefixes for IPv6. In the case of FIG. 6.3, the fields to the left of the Interface ID comprise the prefix.) When connecting a new router into such a system context, address prefixes may already exist for some of the links connected to the router's interfaces while other links may not have address prefixes available. Sometimes, understanding and identifying which router communication links are active but are otherwise coupled to a link in need of an address prefix can be a challenging, time-consuming, and uncertain activity that diverts a human technician from other useful activities.

The IPv6 protocol family anticipates some logistics issues in that endpoints are specifically anticipated to be self configuring. Unfortunately, routers are excluded from these particular provisions. (See, for example, “The DHCP Handbook: Understanding, Deploying, and Managing Automated Configuration Services” by Ralph Droms and Ted Lemon published by Macmillan Technical Publishing in 1999, page 68). Consequently, the protocol itself offers no particular assistance in this regard. Suggestions have been presented that so-called self-discovering networks could alleviate such concerns, but the applicants are unaware of any applicable and enabled network of this nature.

A need therefore exists for at least a partial solution to these challenges.

### BRIEF DESCRIPTION OF THE DRAWINGS

These and other challenges are at least partially met by provision of the method and apparatus disclosed herein. The benefits will become more readily understood upon making a thorough review and study of the following detailed description, particularly when reviewed in conjunction with the drawings, wherein:

FIG. 1 comprises a block diagram depiction of a system configured in accordance with the invention;

FIG. 2 comprises a flow diagram in accordance with the invention; and

FIG. 3 comprises a flow diagram in accordance with the invention.

### DETAILED DESCRIPTION

In one embodiment, a router can identify active communication links to which it has been coupled and then automatically identify which an active communication link or links need a new address prefix or prefixes.

Pursuant to one approach, the router can monitor each active communication link to determine whether any other router is presently supporting that link. Pursuant to another approach, the router can directly solicit other routers on each active link to ascertain the same information. When an active communication link has other router support, the router can automatically self configure the router interface that couples to that communication link with an IPv6 address composed from an IPv6 address prefix given by another router and an existing unique numerical identifier for that interface such as an Institute of Electrical and Electronics Engineers (IEEE) EUI-64 identifier which is often based on the Media Access Control (MAC) address of the interface. For example, this composition can be performed in a manner similar to the method described for an endpoint to compose an IPv6 address given in the Internet Engineering Task Force (IETF) Request for Comments (RFC) 2462, “IPv6 Stateless Address Autoconfiguration.” When no address prefix is available, the router can automatically flag that interface as needing a new address prefix.

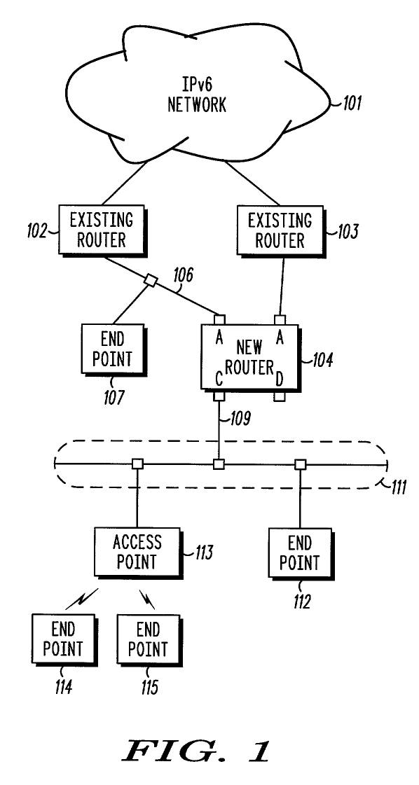

Referring now to FIG. 1, an IPv6 network 101 couples to a first and second existing router 102 and 103. These elements represent an existing system presently in operation. A new router 104, configured and operating in accordance with these teachings and having, in this example, four communication link interfaces A, B, C, and D, couples both to the existing system and to a link that operates compatibly with IPv6 as described below in more detail. This new router 104 can be enabled through use of existing router technology coupled with additional functionality provided through software modifications.

In this exemplary embodiment, the new router 104 has a first interface A that couples to an existing IPv6 link 106. This existing link 106 is supported by an existing router 102 and serves, for example, at least one endpoint 107 (an endpoint can be any user platform, such as a personal computer, or other network endpoint, such as a server). The second interface B of the new router 104 couples to another existing IPv6 link 108 that is supported by a second existing router 103. The third interface C of the new router 104 couples 109 to an IPv6 link 111 that can be, for example, an Ethernet hub.

This link 111 serves, for purposes of this example, an end point 112 and an access point 113. The access point 113 constitutes an IPv6 access point that offers wireless network connectivity to wireless endpoints 114 and 115. For purposes of this example, this link 111 is not being supported by any other router at the time when the new router 104 is coupled 109 to this link 111. Lastly, a fourth interface D of the new router 104 is not coupled to any communication link.

When the new router 104 is first coupled via its interfaces as described, the existing links 106 and 108 are already being supported by other routers. The remaining link 111, however, is not being presently supported by any other router and merely coupling this link 111 to the new router 104 will not, in and of itself, establish full network connectivity. (Connection to the link will allow for the configuration of link local addresses. The endpoints 114, 115, and 112 and the new router 104 can communicate with one another via these link local addresses but cannot communicate beyond the new router 104.) In particular, the communication link has no network address prefix having global or site scope relevancy. Without a network address prefix of relevant scope, the endpoints 112, 114, and 115 cannot compatibly interact with the existing system through the new router 104.

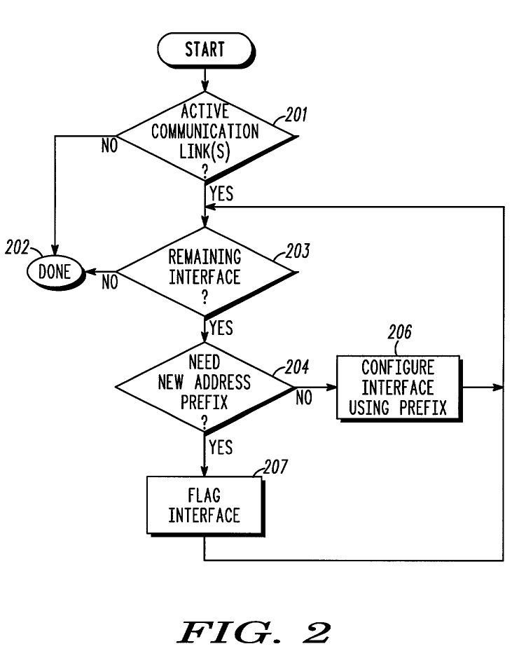

Referring now to FIG. 2, the router 104 can take certain actions on its own accord to begin to alleviate this situation. To begin, the router 104 can monitor 201 its interfaces A-D to identify active communication links. (The definition of “active” is dependent on link type. For example, for an Ethernet link it can be based on whether a carrier is sensed.) In the example provided in FIG. 1 interfaces A, B, and C would be identified as active communication links and interface D would be identified as an inactive communication link. If, for example, the router 104 were powered up but none of its interfaces were connected to an active communication link, this automated process would ascertain that there are no active links and the process would conclude 202 (Optionally, the process could enter a loop (not shown) where it periodically again looks for newly connected active links.). When active communication links are detected 201, however, the process next determines 203 whether any interfaces remain that have not yet been assessed. If all active interfaces have been assessed, the process will conclude 202.

When unassessed interfaces exist, the process ascertains 204 whether a particular interface (and hence the active communication link to which that interface connects) needs a new address prefix (in this embodiment, a new address prefix constitutes an address prefix that has not already been allocated for use by this communication link and/or by this router 104). If the router 104 already has an address prefix that can be utilized to support the communication link that couples to the interface being processed, then a new address prefix is not required and the router 104 can automatically configure 206 an IPv6 address for the interface based on a pre-existing and available address prefix, and then optionally begin advertising this prefix on the link. The process can then loop back to determine whether any other active interfaces remain 203. When the process determines 204, however, that a new address prefix is required for the interface, the process flags 207 that interface (by making an appropriate entry into resident memory of the router, for example) or takes other appropriate action to denote for later recollection and action that this particular interface needs a new address prefix.

Again referring to FIG. 1, the interface C that couples 109 to the IPv6 link 111 would be an interface for which the router 104 would conclude that needs a new address prefix (unless the router 104 had been previously programmed with a network address prefix that could be internally assigned to this interface to support autoconfiguration). The first two interfaces A and B, however, would not need new address prefixes and the interfaces could be autoconfigured with address prefix information as provided by the existing routers 102 and 103 as described below.

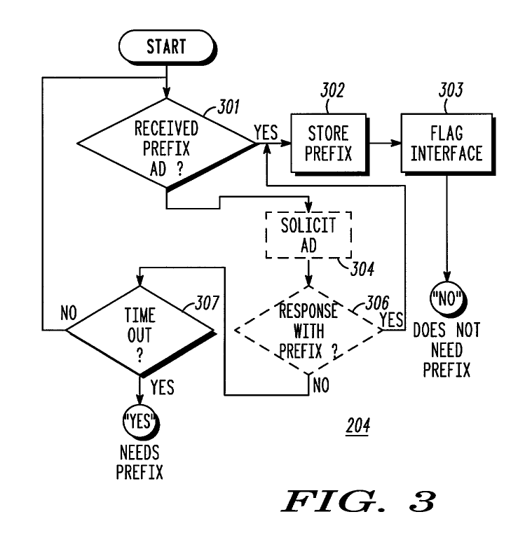

Referring now to FIG. 3, a process 204 by which the router 104 can determine whether a new address prefix is needed will be described. As part of these processes, the router 104 can monitor data traffic on the active communication link for the interface then being studied. As part of this monitoring, the router 104 can look 301 for a received address prefix advertisement (prior art routers often advertise their address prefixes on their supported links to facilitate stateless autoconfiguration by endpoints; see, for example, stateless autoconfiguration as described in Chapter 11 starting on page 173 of the Loshin reference.). When such an address prefix advertisement is received, the prefix can be stored 302 and the corresponding interface flagged 303 accordingly. These actions are one way of making possible the configuration step 206 described above in FIG. 2 by making the address prefix available for autoconfiguration of a router's interface such as interfaces A and B.

When the router 104 cannot detect 301 a received address prefix advertisement from another router, optionally, the router 104 can transmit a solicitation for such an advertisement on the communication link that couples to the interface being processed. Such solicitation messages are allowed by endpoints and should elicit a corresponding network address prefix advertisement from any other configured router on that link. If the router 104 detects 306 a response to such a solicitation, the address prefix portion of that response can be stored 302 and later utilized to autoconfigure 206 (FIG. 2) that particular interface. When no such response is detected 306, or when this optional solicitation step has not been used, the router 104 can determine 307 whether sufficient time has been expended on this particular interface. If not, the process can repeat. Otherwise, the process continues as described in FIG. 2 by flagging the interface 207 as indeed needing a new address prefix.

So configured, a router 104 can automatically self-assess its communication link interfaces. The results of this self-assessment can be utilized to self configure interfaces with address prefixes where appropriate and available and to otherwise identify interfaces that require a new address prefix. The latter information can be utilized to facilitate subsequent actions to obtain the needed new address prefix. The automated nature of this self assessment mechanism can significantly relieve many of the logistic difficulties of bringing a new router online, particularly when interfacing IPv6 links with existing IPv6 networks.

We claim:

1. A method comprising:
at a router:
identifying at least one active communication link to provide an identified active communication link;
automatically identifying whether the router needs a new address prefix for the identified active communication link.

2. The method of claim 1 wherein identifying at least one active communication link includes identifying a plurality of active communication links to provide a plurality of identified active communication links.

3. The method of claim 2 wherein automatically identifying whether the router needs a new address prefix includes identifying whether the router needs a new address prefix for each of the plurality of identified active communication links.

4. The method of claim 1 wherein automatically identifying whether the router needs a new address prefix for the identified active communication link includes automatically determining whether the router needs to advertise a new address prefix for use by link endpoints.

5. The method of claim 1 wherein automatically determining whether the router needs a new address prefix includes automatically determining when the router has not received a prefix advertisement from another router for the same active communication link.

6. The method of claim 5 wherein automatically determining when the router has not received a prefix advertisement from another router for the same active communication link includes automatically determining when the router has not received a prefix advertisement from another router for the same active communication link within a predetermined period of time.

7. The method of claim 4 wherein automatically determining whether the router needs to advertise a new address prefix for use by link endpoints includes automatically determining whether the router needs to advertise an address prefix for use by link endpoints by soliciting at least one router to advertise.

8. A method to automatically support automatic configuration of a network router comprising:
at the network router:
automatically assessing each router link to identify active communication links to provide identified active communication links;
for each identified active communication link:
automatically identifying whether the router needs to support the identified active communication link;
for each identified active communication link that is identified as needing support, automatically identifying whether that identified active communication link requires at least one network address prefix.

9. The method of claim 8 wherein automatically identifying whether the router needs to support the identified active communication link includes automatically monitoring the identified active communication link for prefix advertisements from another router that is supporting communications for the identified active communication link.

10. The method of claim 9 wherein automatically identifying whether the router needs to support the identified active communication link includes automatically determining that the router needs to support the identified active communication link when no other router has transmitted a prefix advertisement for the monitored identified active communication link.

11. A router comprising:
first means for automatically identifying at least one active communication link to provide an identified active communication link; and
second means for automatically identifying when the router needs to provide a new address prefix for the identified active communication link.

12. The router of claim 11 wherein the first means is further for automatically identifying a plurality of active communication links to provide a plurality of identified active communication links.

13. The router of claim 11 wherein the second means is further for automatically identifying when the router needs to provide a new address prefix for each of the plurality of identified active communication links.

14. The router of claim 11 wherein the second means is further for automatically determining when the router needs to advertise a new address prefix for use by link endpoints.

15. The router of claim 11 wherein the second means is further for automatically determining when the router needs to advertise a new address prefix for use by at least one link endpoint by soliciting at least one other router to advertise.
